(19) United States
(12) Patent Application Publication
(10) Pub. No.: US 2024/0176073 A1
(43) Pub. Date: May 30, 2024

(54) SEMICONDUCTOR STRUCTURE AND METHOD OF MANUFACTURE

(71) Applicant: SMART PHOTONICS HOLDING B.V., Eindhoven (NL)

(72) Inventors: Alonso Jesús MILLÁN-MEJÍA, Eindhoven (NL); Paul TIEBOT, Eindhoven (NL)

(21) Appl. No.: 18/431,872

(22) Filed: Feb. 2, 2024

Related U.S. Application Data
(63) Continuation of application No. PCT/EP2022/071880, filed on Aug. 3, 2022.

(30) Foreign Application Priority Data
Aug. 5, 2021 (GB) 2111320.4

(51) Int. Cl. G02B 6/122; G02B 6/132; G02B 6/136

(52) U.S. Cl. CPC G02B 6/1228; G02B 6/1223; G02B 6/132; G02B 6/136

(57) ABSTRACT

A semiconductor structure for a photonic integrated circuit, comprising a substrate, and a waveguide. The substrate comprises a planar surface. The waveguide comprises a first waveguide portion and a second waveguide portion. The first waveguide portion tapered for a first spot size conversion of light, and in contact with a first portion of the planar surface. The second waveguide portion in contact with a second portion of the planar surface next to the first portion of the planar surface. A size of the first waveguide portion in a first direction perpendicular to a light propagation direction is less than a size of the second waveguide portion in the first direction for a second spot size conversion of the light.

### CROSS-REFERENCE TO RELATED APPLICATIONS

This application is a continuation under 35 U.S.C. § 120 of International Application No. PCT/EP2022/071880, filed Aug. 3, 2022 which claims priority to United Kingdom Application No. GB 2111320.4, filed Aug. 5, 2021, under 35 U.S.C. § 119(a). Each of the above-referenced patent applications is incorporated by reference in its entirety.

### BACKGROUND

Semiconductor structures can be used in photonic integrated circuits (PICs) to perform various functions. In some applications, light may be input into or output from the PIC. For example, light is output from the PIC into an optical fibre which carries the output light to another device as input. In some examples, it is desirable to modify the light before it is output so that it is suitable for the optical fibre.

### BRIEF DESCRIPTION OF THE DRAWINGS

FIG. 1 illustrates schematically a first side cross-section of a first semiconductor structure according to examples;

FIG. 2 illustrates schematically a plan cross-section of the first semiconductor structure according to examples;

FIG. 3 illustrates schematically a second side cross-section of the first semiconductor structure according to examples;

FIG. 4 illustrates a plan cross-section of a second semiconductor structure according to examples;

FIG. 5 illustrates a plan cross-section of a third semiconductor structure according to examples;

FIG. 6 illustrates schematically a side cross-section of the third semiconductor structure according to examples;

FIG. 7 illustrates part of a method of manufacturing a semiconductor structure according to examples;

FIGS. 8a-8d each illustrate schematically a side cross section of a semiconductor structure at sequential stages during manufacture according to examples; and

FIG. 9 illustrates part of the method of manufacturing the semiconductor structure according to examples.

### DETAILED DESCRIPTION

Examples described herein relate to a semiconductor structure for a PIC. More specifically, examples described herein relate to a semiconductor structure which converts the spot size of light.

Light can be input into a PIC from an optical fibre or output from a PIC to an optical fibre. Light propagating within a PIC has a spot size appropriate for the physical size of the components of the PIC, such as the waveguides. However, optical fibres are typically for carrying light with a larger spot size. In the context of light being output to an optical fibre, it is desirable to increase the spot size of the light before it is output to the optical fibre.

As used herein, spot size relates to the cross-sectional area of a beam of light in a plane perpendicular to the direction in which the light is propagating. For example, the magnitude of the spot size in each of two orthogonal directions (e.g. width and height) can be changed by examples of the semiconductor structure described herein. As explained later, the size of the spot in two orthogonal directions (e.g. height and width) can be changed directly proportionally to each other, so that the shape of the beam's cross-sectional area is e.g. the same before and after the first and second spot size conversions. In other examples, by changing the size in the two orthogonal directions differently to each other, in accordance with a pre-determined ratio, the shape of the cross-sectional area after the first and second spot size conversions can be changed relative to before the conversions. Those skilled in the art will appreciate that there are various definitions of a spot of a beam of light and what is taken as its cross-sectional area. E.g., a beam diameter of light can be used to define the spot size. One definition is the full width at half maximum (FWHM), which relates to the width of the intensity profile (in a direction perpendicular to the light propagation direction) at half of the peak intensity of the light. Other definitions include 1/e² and D4Σ (second moment width), as the skilled person will appreciate.

The following discussion relates to converting the spot size of light within a PIC in two directions, each perpendicular to one another and to the light propagation direction.

For spot size conversion in two orthogonal directions which are perpendicular to the light propagation direction, a semiconductor structure for spot size conversion is desired which is easier to manufacture, e.g. monolithically and/or without needing to provide waveguide layers at different vertical levels within a structure, and/or without needing to create tapers in layer thickness using wet etching techniques that result in undesirably rough surfaces of a waveguide.

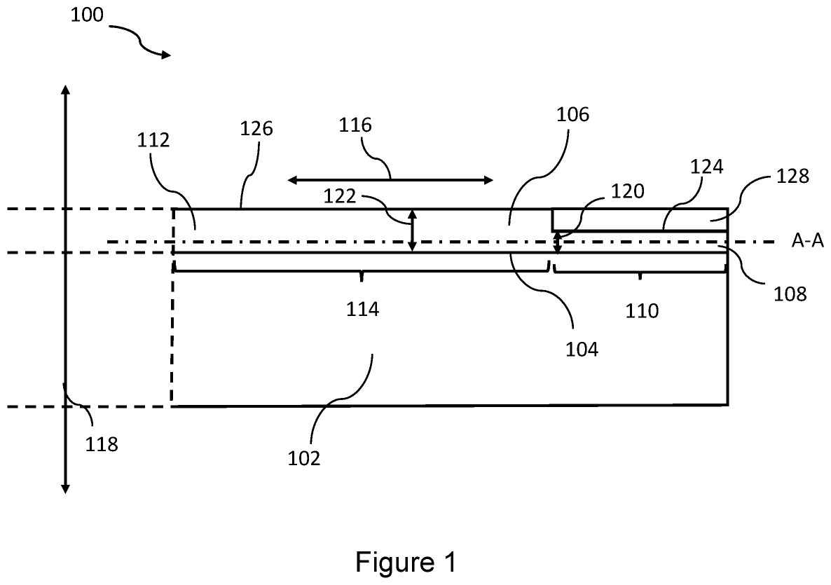

FIG. 1 illustrates schematically a side cross-section of a semiconductor structure 100 for a PIC according to examples. Other examples of a semiconductor structure for spot size conversion are described later. The semiconductor structure 100 is for converting a spot size of light. The semiconductor structure 100 is hereafter simply referred to as the structure 100 for brevity. The structure 100 comprises a substrate 102 comprising a planar surface 104. The planar surface 104 is substantially planar, so is for example planar or flat, e.g. within acceptable functional and manufacturing tolerances, or more generally planar in that it corresponds to a single plane.

In some examples, the substrate 102 comprises a so-called III-V semiconductor compound such as Indium Phosphide (InP), gallium arsenide (GaAs), gallium nitride (GaN) or gallium antimonide (GaSb). In other examples, the substrate comprises a Nitride based material or a Silicon based material.

The structure 100 comprises a waveguide 106. In these examples, the waveguide 106 comprises a first waveguide portion 108 tapered for a first spot size conversion of light and in contact with a first portion 110 of the planar surface 104. In these examples, the structure 100 comprises a second waveguide portion 112 in contact with a second portion 114 of the planar surface 104. The second portion of the planar surface is next to the first portion of the planar surface, e.g. so that in examples the first waveguide portion contacts the second waveguide portion. A size of the first waveguide portion 108 in a first direction 118 perpendicular to a light propagation direction 116 is less than a size of the second waveguide portion 112 in the first direction 118 for a second spot size conversion of the light. In the examples of FIG. 1, the substrate 102, the first waveguide portion 108 and the second waveguide portion 112 are monolithically integrated in the semiconductor structure 100. In the orientation shown in FIG. 1, the light propagation direction extends between the left and right of the page.

The waveguide 106 is for guiding light. In use, light propagates within the waveguide 106 and is confined within the waveguide 106, due to reflection at the boundaries of the waveguide 106. The waveguide 106 has a refractive index higher than the refractive index of material in contact with the waveguide 106 at the boundaries at which confinement of light is desired. For example, due to this refractive index difference at the boundaries at which confinement of light is desired, total internal reflection takes place when the angle of incidence at these boundaries of the waveguide 106 is greater than the critical angle. In this manner, the waveguide 106 guides the propagation of the light. For a particular optical mode to propagate in the waveguide 106, it is desired that the light reflected at the boundaries of the waveguide 106 fulfils the conditions for constructive interference, as will be appreciated by the skilled person.

For example, particular optical modes of light are desired to propagate through the waveguide 106 depending on the desired application of the region of the PIC in question. The direction in which the optical modes propagate within the waveguide 106 is herein referred to as the light propagation direction. The light propagation direction is the general direction in which the energy of the optical mode travels through the waveguide 106 and is not necessarily, for example, the direction defined by the angle of incidence at a boundary of the waveguide 106. As described above, in the examples of FIG. 1, the light propagation direction is indicated by the arrow 116. In some applications, light propagates from left to right in the orientation of FIG. 1, while in other applications, light propagates from right to left in the orientation of FIG. 1.

In the examples of FIG. 1, the first waveguide portion 108 and the second waveguide portion 112 are of the same material. In other examples, the first waveguide portion 108 and the second waveguide portion 112 are of different materials to one another, e.g. depending on the application.

In the examples of FIG. 1, the waveguide 106 comprises a material which has a higher refractive index than the material of the substrate 102. For example, the waveguide 106 comprises Indium Gallium Arsenide Phosphide (InGaAsP). More generally, in some examples, the waveguide 106 comprises (Al)InGaAs(P). The elements indicated in the parentheses can be interchangeable and the composition of the different elements is selected depending on the desired function. For example, the composition of Ga and As in InGaAs can be selected according to the desired bandgap.

In the examples of FIG. 1, the first direction 118 is substantially (within acceptable tolerances) perpendicular to the planar surface 104. In other examples, the first direction is oriented differently, as described further below. In the examples of FIG. 1, the first direction 118 is the vertical direction with respect to the orientation of FIG. 1, as indicated by the arrow indicated by the numeral 118. Accordingly, in these examples, the size 120 of the first waveguide portion 108 in the first direction 118 is the thickness of the first waveguide portion 108. In these examples, the size 122 of the second waveguide portion 112 in the first direction 118 is the thickness of the second waveguide portion 112.

The size 120 of the first waveguide portion 108 in the first direction 118 in the examples of FIG. 1 is hereafter referred to as the thickness 120 of the first waveguide portion 108. The size 122 of the second waveguide portion 112 in the first direction 118 in the examples of FIG. 1 is hereafter referred to as the thickness 122 of the second waveguide portion 112.

In the examples of FIG. 1, the first waveguide portion 108 is thinner than the second waveguide portion 112. Both the first and second waveguide portions 108, 112 are in contact with the planar surface 104 such that they are on the same plane as each other.

The difference in the size of the first and second waveguide portions 108, 112 in the first direction 118 at least partly provides the second spot size conversion. In other words, the difference in thickness between the first and second waveguide portions 108, 112 at least partly provides the second spot size conversion of the light. In these examples, the second spot size conversion is a change in spot size in the first direction 118. In these examples, the second spot size conversion is an increase of the spot size in the first direction 118 for light propagating from the second waveguide portion 112 to the first waveguide portion 108. This results from the smaller thickness 120 of the first waveguide portion 108. In these examples, the thickness 120 of the first waveguide portion 108 is not enough to effectively confine, in the first direction 118, the mode of light in question as compared to the second waveguide portion 112 with the greater thickness 120. Therefore, the mode of light in question expands in the first direction 118 and the spot size in the first direction 118 becomes larger as the mode of light in question passes into the first waveguide portion 108.

A difference in the thickness of different waveguide portions can be achieved in different ways. In the examples of FIG. 1, the size 120 of the first waveguide portion 108 in the first direction 118 is less than the size 122 of the second waveguide portion 112 in the first direction 118, such that a surface 124 of the first waveguide portion 108 is stepped relative to a surface 126 of the second waveguide portion 112, the surface 124 of the first waveguide portion 108 next to the surface 126 of the second waveguide portion 112. The manner in which the stepped surface is manufactured is described further below. Providing a stepped surface such as that shown in the examples of FIG. 1 has manufacturing advantages as compared to providing a thickness taper, for example. For example, performing wet etching to provide a thickness taper can provide a rough tapered surface of the waveguide portion in question. This is undesirable for some applications e.g. where optical losses due to a rough tapered surface would be too great for the intended application.

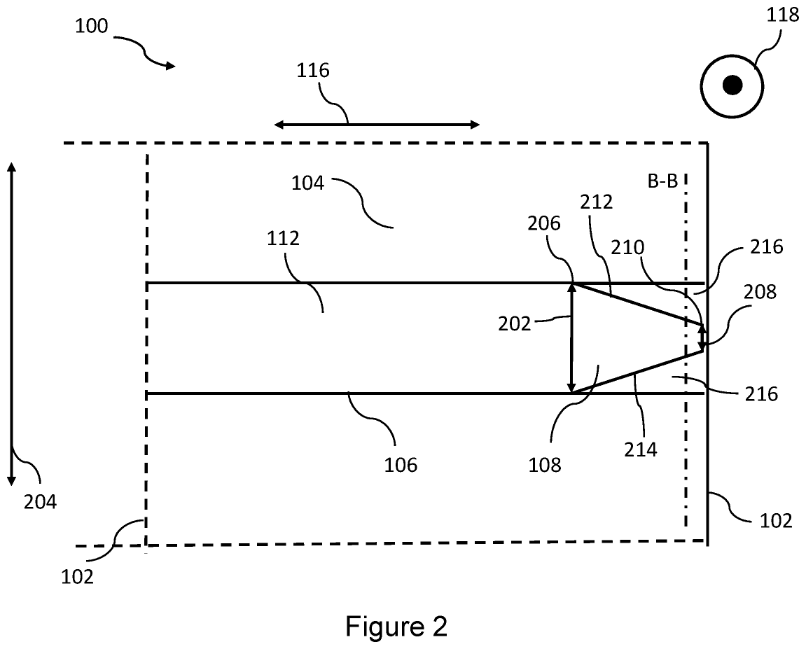

FIG. 2 illustrates schematically a plan view cross section of the structure 100 according to examples. The cross section shown in FIG. 2 is take at line A-A indicated in FIG. 1. The examples of FIG. 2 show the manner in which the first waveguide portion 108 is tapered according to these examples. The taper of the first waveguide portion 108 provides a geometry which at least partly provides the first spot size conversion of the light, as will be discussed further below. It should be noted that the first spot size conversion as referred to herein relates to a change in spot size provided for by the taper of the first waveguide portion 108 as described below.

In the examples of FIG. 2, a size 202 of the first waveguide portion 108 in a second direction 204, perpendicular to the first direction 118 and the light propagation direction 116, at a first location 206 along the light propagation direction 116 is greater than a size 208 of the first waveguide portion 108 in the second direction 204 at a second location 210 along the light propagation direction 116. In these examples, the first location 206 is closer to the second waveguide portion 112 than the second location 210. The size in the second direction 204 can be referred to as the width of the portion in question.

In the examples of FIG. 2, the first location 206 corresponds to a part of the first waveguide portion 108 closest to the second waveguide portion 112, and the second location 210 corresponds to a part of the first waveguide portion 108 farthest from the second waveguide portion 112. In the examples of FIG. 2, the width 202 of the first waveguide portion 108 at the first location 206 is substantially (within acceptable tolerances) the same as the width (size in the second direction 204) of the second waveguide portion 112 where the first waveguide portion 108 contacts the second waveguide portion 112.

The geometry of the first waveguide portion 108 is different depending on the position along the light propagation direction 116. The geometry is different in that the width of the first waveguide portion 108 is different depending on the position along the light propagation direction 116. This at least partly provides the first spot size conversion of the light which is a change in the spot size in the second direction 204. In these examples, the first spot size conversion is an increase of the spot size in the second direction 204 for light propagating through the first waveguide portion 108 away from the second waveguide portion 112.

For example, as the mode of light in question propagates from a larger width part of the first waveguide portion 108 to a smaller width part of the first waveguide portion 108, the mode of light becomes less confined width wise and the spot size in the second direction 204 increases.

The first spot size conversion is at least partly the result of the width geometry of the first waveguide portion 108. The magnitude of the first spot size conversion depends on a magnitude of a change in size of the first waveguide portion 108 in the second direction 204, and hence the proportions of the first waveguide portion. In other words, the magnitude of the first spot size conversion depends on the change in width, e.g. a width difference, of the first waveguide portion 108 along the second direction. Such a width difference is for example the difference between the largest width of the first waveguide portion 108 and the smallest width of the first waveguide portion 108. In the examples of FIG. 2, such a width difference is the difference between the width 202 at the first location 206 and the width 208 at the second location 210.

In the examples of FIG. 2, the first waveguide portion 108 comprises a first surface 212 and a second surface 214. Each of the first surface 212 and the second surface 214 extends away from the planar surface 104. For example, the first and second surfaces 212, 214 extend in the first direction 118. In the examples of FIG. 2, the first and second surface 212, 214 is substantially (within acceptable tolerances) flat. In the examples of FIG. 2, the taper of the first waveguide portion 108 is provided by the first and second surfaces 212, 214 being at an acute angle relative to the second direction 204 such that at a location progressively farther away from the second waveguide portion, the size of the first waveguide portion 108 in the second direction is less.

In other examples, instead of the first and second surfaces 212, 214 being substantially flat and angled relative to the second direction 204 as described, there are provided side surfaces with stepped portions. Such side surfaces, for example, comprise a plurality of stepped portions such that at a location progressively farther away from the second waveguide portion 112, the width of the first waveguide portion 108 is less. In such examples, the taper of the first waveguide portion 108 is provided in a stepped manner.

As described above, in examples, the second spot size conversion is in the first direction 118, and the first spot size conversion is in the second direction 204. Using a combination of the first and second spot size conversion, the spot size of light in the plane perpendicular to the light propagation direction 116 can be controlled.

As described above, the second spot size conversion depends on the difference in the size of the first and second waveguide portions 108, 112 in the first direction 118 (referred to in the following as a first size difference for brevity), and the first spot size conversion depends on the magnitude of the change in size of the first waveguide portion 108 in the second direction 204 (referred to in the following as a second size difference for brevity). As will be appreciated, the first and second waveguide portions are proportioned, for example in accordance with a pre-determined ratio between the first size difference and the second size difference, such that the first spot size conversion is greater in magnitude than the second spot size conversion; the second spot size conversion is greater in magnitude than the first spot size conversion; or the first spot size conversion and the second spot size conversion being substantially equal in magnitude.

The following relates to illustrative examples in which light propagating in the second waveguide portion 112 has a spot size in the first and second directions that provides a substantially circular spot. In these examples, light propagates from the second waveguide portion 112 towards the first waveguide portion 108. In some such examples with the first spot size conversion greater in magnitude than the second spot size conversion, the light output from the first waveguide portion 108 corresponds to a non-circular elliptical spot greater in size in the first direction 118 than in the second direction 204. In other such examples instead having the second spot size conversion greater in magnitude than the first spot size conversion, the light output from the first waveguide portion 108 corresponds to a non-circular elliptical spot greater in size in the second direction 204 than in the first direction. In further such examples instead having the first spot size conversion and the second spot size conversion being substantially equal in magnitude, the light output from the first waveguide portion 108 corresponds to a substantially circular spot. Accordingly, changing the described ratio in the design of the semiconductor structure can be used to change the size and, in some examples, also the shape of the spot of light. The pre-determined ratio depends on the desired application. For example, the pre-determined ratio depends on the cross-section of the optical fibre to which the structure 100 is intended to optically couple.

Referring again to FIG. 1, in these examples, the structure 100 comprises a cladding layer 128 in contact with the first waveguide portion 108. The cladding layer 128 overlaps the first portion 110 of the planar surface 104. In the examples of FIG. 1, the cladding layer 128 is on top of the first waveguide portion 108 with respect to the orientation shown in FIG. 1. In these examples, the combined thickness (size in the first direction 118) of the first waveguide portion 108 and the cladding layer 128 is substantially (within acceptable tolerances) the same as the thickness of the second waveguide portion 112. The cladding layer 128 is of a material with a lower refractive index than the material of the first waveguide portion 108. The material of the cladding layer 128 may be referred to as the cladding material. As used herein, cladding material is a material other than air. However, the difference in refractive index between the first waveguide portion and the cladding layer 128 is low enough to provide deconfinement of the desired optical mode of light propagating within the first waveguide portion 108 to at least partly provide the spot size conversion. Those skilled in the art will appreciate that the higher the refractive index difference, the stronger the confinement.

In the examples of FIG. 2, the structure 100 comprises cladding material 216 in contact with the first surface 212 and the second surface 214. Cladding material 216 in contact with the first and second surfaces 212, 214 provide a lower refractive index difference at the boundaries provided by the first and second surfaces 212, 214 than if the first and second surfaces 212, 214 were in contact with air, for example. This provides for deconfinement of the desired optical mode in the second direction 204.

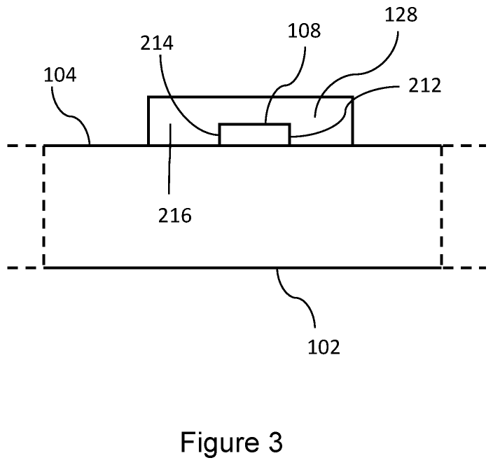

FIG. 3 illustrates schematically a side cross section of the structure 100 along the line B-B shown in FIG. 2. It can be seen from FIG. 3 that, in these examples, there is cladding material 216 in contact with the first surface 212 and the second surface 214.

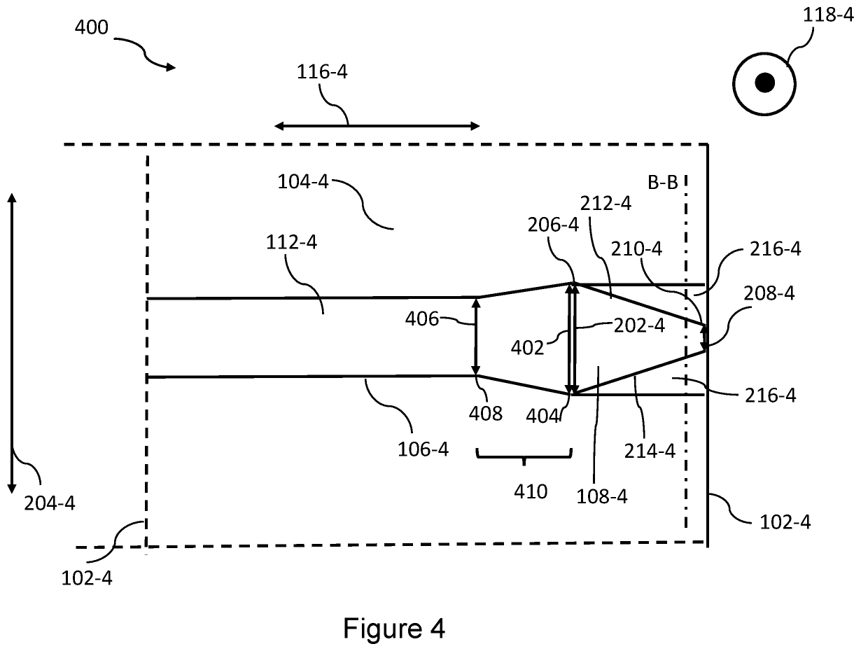

FIG. 4 illustrates schematically the same plan view cross section as that of FIG. 2 but for a semiconductor structure 400 according to different examples. Features corresponding to those shown in FIGS. 1-3 are labelled with similar reference numerals with the additional numeral “−4” added at the end in FIG. 4. The structure 400 has any combination of the features described above with respect to the structure 100. In addition, the examples of FIG. 4 have the following features.

In the examples of FIG. 4, a size 402 of the second waveguide portion 112-4 in the second direction 204-4 at a third location 404 along the light propagation direction 116-4 is greater than the size 406 of the second waveguide portion 112-4 in the second direction 204-4 at a fourth location 408 along the light propagation direction 116-4. In these examples, the third location 404 is closer to the first waveguide portion 108 than the fourth location 408. As described above, the second direction 204-4 is perpendicular to the first direction 118-4 (out of the page in FIG. 4) and the light propagation direction 116-4. In these examples, the second waveguide portion 112-4 comprises a section 410 with a taper in which the width is greater closer to the first waveguide portion 108-4 as shown. In these examples, the width of the second waveguide portion 112-4 is greater closer to the first waveguide portion 108-4 such that the widths of the first and second waveguide portion 108-4, 112-4 are similar to one another where the second waveguide portion 112-4 contacts the first waveguide portion 108-4. For example, the second waveguide portion 112-4 other than the section 410 has a smaller width (compared to the width where the first and second waveguide portions 108-4, 112-4 meet) in accordance with the desired application. However, closer to the first waveguide portion 108-4, the width of the second waveguide portion 112-4 is tapered so that it is similar to the width of the first waveguide portion 108-4 where the first and second waveguide portions 108-4, 112-4 contact one another. In some examples, the first and second waveguide portions 108-4, 112-4, where they contact one another, have substantially (within acceptable manufacturing tolerances) matching widths, which can give low losses for light propagating from one portion to the other. The section 410 tapered to have a greater width closer to the first waveguide portion 108-4 provides for the first and second waveguide portions 108-4, 112-4 being positioned relative to each other, for light coupling therebetween, with less strict tolerances.

In the examples described above, the first direction 118, 118-4 is substantially perpendicular to the planar surface 104, 104-4. However, in other examples, the first direction is substantially parallel to the planar surface of the substrate, with the second direction perpendicular to the first direction. In these examples, the first and second directions are perpendicular to the light propagation direction. In these examples, as for the examples described above, a size of the first waveguide portion in the first direction is less than a size of the second waveguide portion in the first direction for a second spot size conversion.

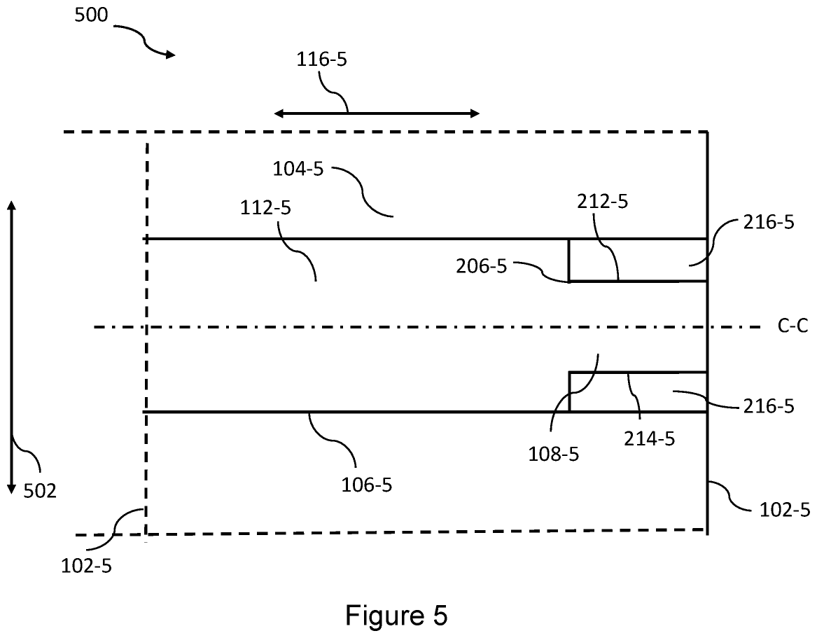

FIG. 5 illustrates schematically the same plan view cross section as that of FIG. 2 but for a semiconductor structure 500 according to further examples. Features corresponding to those shown in FIGS. 1-4 are labelled with similar reference numerals with the additional numeral “−5” added at the end in FIG. 5. The structure 500 has any combination of the features described above with respect to the structures 100 and 400, except for the following differences.

In the examples of FIG. 5, the first direction 502 is perpendicular to the light propagation direction 116-5, and parallel to the planar surface 104-5 of the substrate 102-5. In these examples, a size in the first direction 502 can be referred to as a width. The width of the first waveguide portion 108-5 is less than the width of the second waveguide portion 112-5 for the second spot size conversion. In the examples of FIG. 5, the second spot size conversion is a change in the spot size of light in the first direction 502 (width). The difference in width between the first and second waveguide portions 108-5, 112-5 at least partly provides the second spot size conversion. In these examples, the second spot size conversion is to increase the spot size in the first direction 502 for light propagating from the second waveguide portion 112-5 to the first waveguide portion 108-5. In these examples, the width of the first waveguide portion 108-5 is not enough to effectively confine, in the first direction 502, the mode of light in question as compared to the second waveguide portion 112-5 with the greater width. Therefore, the mode of light in question expands in the first direction 502 and the spot size in the first direction 502 becomes larger as the mode of light in question passes into the first waveguide portion 108-5.

In the example structures 500, the first waveguide portion is tapered in the second direction. In these examples, the second direction is perpendicular to the first direction 502 and the light propagation direction 116-5. In these examples, a size in the second direction can be referred to as a thickness. In these examples, the first waveguide portion has a thickness taper.

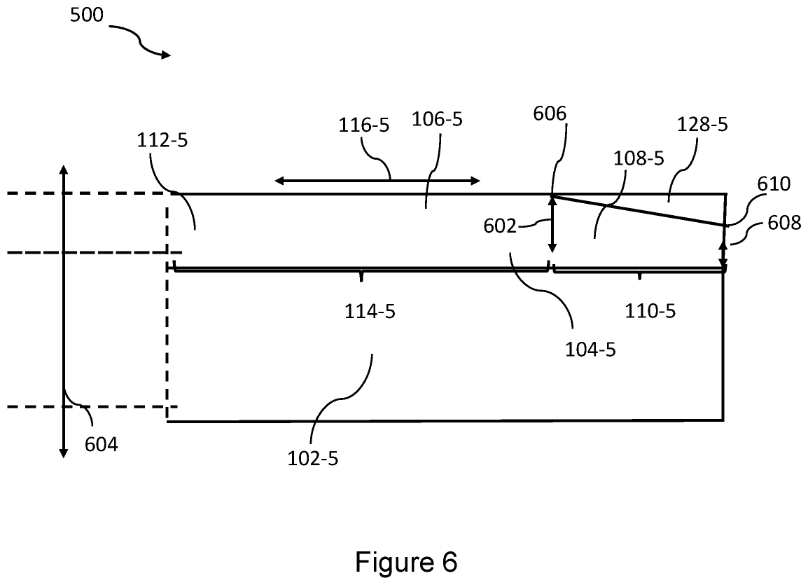

FIG. 6 illustrates schematically a side-cross section of the structure 500 taken along the line C-C in FIG. 5. A size 602 of the first waveguide portion 108-5 in the second direction 604 at a first location 606 along the light propagation direction 116-5 is greater than a size 608 of the first waveguide portion 108-5 in the second direction 604 at a second location 610 along the light propagation direction. The first location 606 is closer to the second waveguide portion 112-5 than the second location 610.

The thickness taper of the first waveguide portion 108-5 at least partly provides the first spot size conversion. In these examples, the first spot size conversion of the light which is a change in the spot size in the second direction 204. In these examples, the first spot size conversion is to increase the spot size in the second direction 604 for light propagating through the first waveguide portion 108-5 away from the second waveguide portion 112-5. While the structure 500 comprises a thickness taper, it is easier to manufacture, e.g. monolithically and does not have waveguide layers at different vertical levels within the structure to provide spot size conversion.

In some examples, there is provided a photonic integrated circuit comprising the semiconductor structure according to any of the examples described above or within the scope of the appended claims. In some such examples, an end of the first waveguide portion is configured for connection with an optical component (e.g. a waveguide) external to the PIC, for coupling light into and/or out of the PIC. In some such examples, the first waveguide portion comprises an input/output end opposite to an end of the first waveguide portion at a position where the first waveguide portion contacts the second waveguide portion.

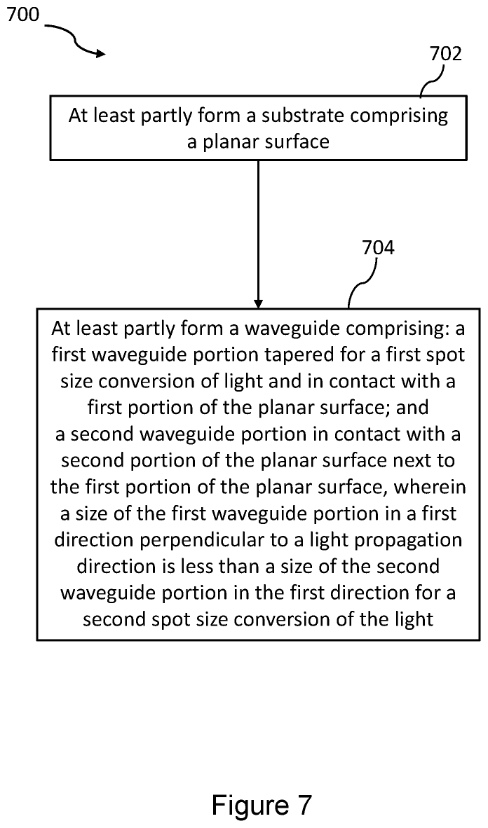

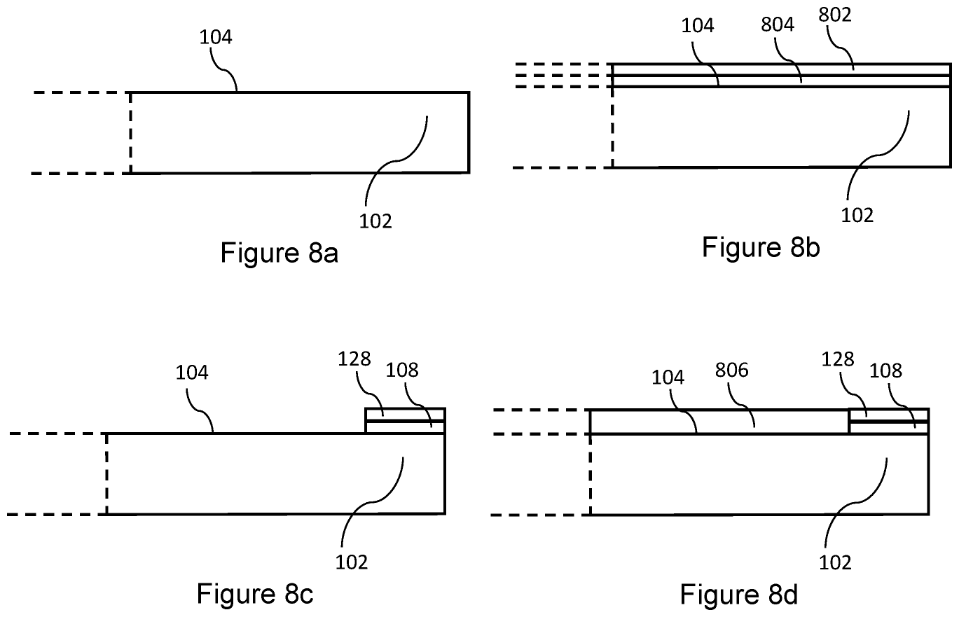

FIG. 7 illustrates part of a method 700 of manufacturing a semiconductor structure (such as any example of the semiconductor structure described above) for a PIC. At block 702 of the method 700, a substrate comprising a planar surface is at least partly formed. FIG. 8a-d illustrate schematically side cross-sections of some examples of a structure obtained from performing some examples of the method 700. FIGS. 8a-d can relate to the examples shown in FIGS. 1-6, however, the reference numerals corresponding to the structure 100 are used for brevity. FIG. 8a illustrates schematically an example substrate (e.g. the substrate 102) resulting from performing block 702.

At block 704 of the method 700, a waveguide is at least partly formed. The waveguide comprises a first waveguide portion tapered for a first spot size conversion of light and in contact with a first portion of the planar surface; and a second waveguide portion in contact with a second portion of the planar surface next to the first portion of the planar surface, wherein a size of the first waveguide portion in a first direction perpendicular to a light propagation direction is less than a size of the second waveguide portion in the first direction for a second spot size conversion of the light.

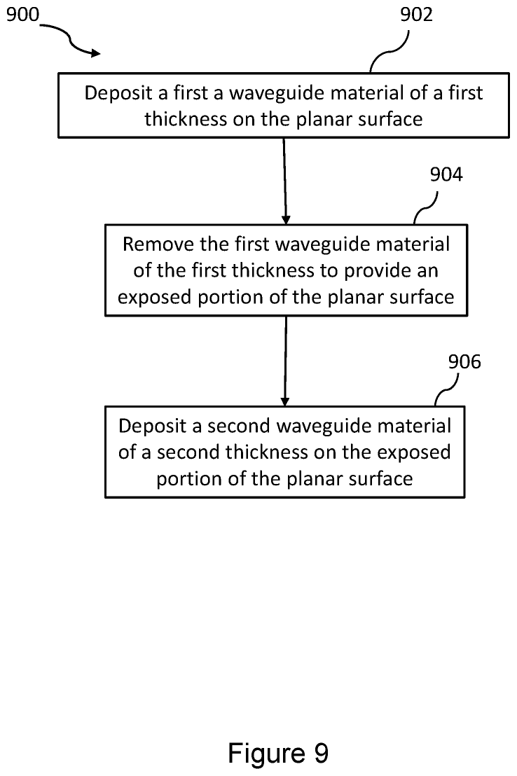

FIG. 9 illustrates a method 900 of at least partly forming the waveguide. The method 900 is, for example, performed as part of block 704 of the method 700. At block 902 of the method 900, a first waveguide material of a first thickness is deposited on the planar surface (e.g. the planar surface 104). For example, the first waveguide material is deposited in a quantity/for an amount of time (depending on the deposition technique) so as to create a layer of the first thickness.

At block 904 of the method 900, the first waveguide material of the first thickness is removed to provide an exposed portion (which includes the second portion) of the planar surface. In some examples of block 904, removing the first waveguide material of the first thickness to provide the exposed portion provides the first waveguide portion of the first waveguide material. For example, the first waveguide material is removed from the planar surface except from the first portion of the planar surface. In some such examples, a mask is placed on the first waveguide material where it is not intended to remove the first waveguide material, and an etching technique is performed to remove the first waveguide material not covered by said mask. For example, the mask is be used to provide the desired shape of the first waveguide portion (e.g. the above described taper, or the shape shown in FIG. 2).

In some such examples, the method 900 comprises depositing a cladding material 802 on the first waveguide material 804 before removing the first waveguide material 804 of the first thickness to provide the exposed portion of the planar surface. For example, the first waveguide material corresponds to the first waveguide portion 108, and the cladding material corresponds to the cladding layer 128 described above. In these examples of block 904, FIG. 8b shows the resulting structure before removal of the first waveguide material 804. In these examples, removing the first waveguide material 804 to provide the exposed portion results in the structure shown in FIG. 8c.

At block 906 of the method 900, a second waveguide material of a second thickness is deposited on the exposed portion of the planar surface. In some examples, the first thickness is different to the second thickness. FIG. 8d shows an example in which the second waveguide material 806 is deposited on the exposed portion.

In examples, the second waveguide material of the second thickness is partly removed to provide the second waveguide portion. For examples, the second waveguide material is removed from either side to e.g. provide the second waveguide portion as shown in FIG. 2, 4 or 5.

In some examples, cladding material is deposited to contact the sides of the first waveguide portion which extend away from the planar surface. Depositing cladding material in this manner, for example provide cladding material as shown in FIG. 2, 4 or 5.

In the examples shown in FIG. 8a-d, the first thickness is different to the second thickness. In some examples, the first thickness is the same as the second thickness and a wet etch procedure is performed to provide the structure shown in FIG. 6.

In the examples described above, the first waveguide material corresponds to the first waveguide portion. In other examples, the first waveguide material corresponds to the second waveguide portion, in that the second waveguide portion comprises the first waveguide material. In these examples, material for the second waveguide portion is deposited before the material for the first waveguide portion. In some such examples (which do not provide a thickness taper), the first thickness is greater than the second thickness.

In these examples, removing the first waveguide material to provide the exposed portion provides the second waveguide portion. When the second waveguide material (for the first waveguide portion in these examples) is deposited, parts of the second waveguide material are subsequently removed to provide the first waveguide portion. In these examples, cladding material of a third thickness is deposited on the second waveguide material, where the second thickness and the third thickness together are substantial the same as the first thickness. This results in the structure shown in FIG. 8d.

Those skilled in the art will appreciate that a method can be performed where material for the second waveguide portion is deposited before material for the first waveguide portion, the first thickness is the same as the second thickness, and a wet etch procedure is performed to provide a thickness taper for the first waveguide portion.

In the above description, reference is made to at least partly forming layers and the like. In some examples, a layer referred to in this manner is simply formed by depositing the relevant material, without requiring further steps. In other examples, further steps are performed to complete the formation of a layer (for example, a curing step, an etching step to define the extent of a layer, etc.). In some examples, the further steps to complete the formation of a layer are performed before further material is deposited on top of the layer in question. In other examples, the further steps to complete the formation of a layer are performed after further material is deposited on top of the layer in question.

As the skilled person will appreciate, various techniques can be used to deposit the material in accordance with described examples. Such techniques include, for example, chemical vapour deposition techniques such as vapour phase epitaxy (VPE) metalorganic vapour-phase epitaxy (MOVPE) or molecular beam epitaxy (MBE). The skilled person will appreciate that etching techniques (for example, using patterned masks) are used to remove material in accordance with described examples. The above examples are to be understood as illustrative examples.

In the described Figures, dashed lines are included at the edges of certain parts to indicate continuation of the parts in question beyond what is schematically illustrated in the Figures. The Figures include schematic illustrations of structures related to the described examples of the semiconductor structures. None of the Figures should be taken to indicate precise proportions with respect to any other Figure.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

What is claimed is:

1. A semiconductor structure for a photonic integrated circuit, comprising:
a substrate comprising a planar surface;
a waveguide comprising:
a first waveguide portion tapered for a first spot size conversion of light and in contact with a first portion of the planar surface; and
a second waveguide portion in contact with a second portion of the planar surface next to the first portion of the planar surface, wherein a size of the first waveguide portion in a first direction perpendicular to a light propagation direction is less than a size of the second waveguide portion in the first direction for a second spot size conversion of the light.

2. The semiconductor structure according to claim 1, wherein:
the size of the first waveguide portion in the first direction is less than the size of the second waveguide portion in the first direction, such that a surface of the first waveguide portion is stepped relative to a surface of the second waveguide portion, the surface of the first waveguide portion next to the surface of the second waveguide portion.

3. The semiconductor structure according to claim 1 or claim 2 wherein:
a size of the first waveguide portion in a second direction, perpendicular to the first direction and the light propagation direction, at a first location along the light propagation direction is greater than a size of the first waveguide portion in the second direction at a second location along the light propagation direction, the first location closer to the second waveguide portion than the second location.

4. The semiconductor structure according to claim 3, wherein:
a size of the second waveguide portion in the second direction at a third location along the light propagation direction is greater than the size of the second waveguide portion in the second direction at a fourth location along the light propagation direction, the third location closer to the first waveguide portion than the fourth location.

5. The semiconductor structure according to any preceding claim, wherein the first waveguide portion and the second waveguide portion are proportioned such that:
the first spot size conversion is greater in magnitude than the second spot size conversion;
the second spot size conversion is greater in magnitude than the first spot size conversion; and
the first spot size conversion and the second spot size conversion are substantially equal in magnitude.

6. The semiconductor structure according to any preceding claim, wherein:
the first spot size conversion is an increase of spot size in the second direction for light propagating through the first waveguide portion away from the second waveguide portion.

7. The semiconductor structure according to any preceding claim, wherein:
the second spot size conversion is an increase of spot size in the first direction for light propagating from the second waveguide portion to the first waveguide portion.

8. The semiconductor structure according to any one of the preceding claims, wherein:
the first waveguide portion and the second waveguide portion are of the same material.

9. The semiconductor structure according to any one of the preceding claims, wherein:
the substrate, the first waveguide portion and the second waveguide portion are monolithically integrated into the semiconductor structure.

10. The semiconductor structure according to any one of the preceding claims, wherein:
the first waveguide portion comprises a first surface and a second surface, each extending away from the planar surface; and
the semiconductor structure comprises a cladding material in contact with the first surface and the second surface.

11. The semiconductor structure according to claim 10, wherein:
the cladding material has a first refractive index between 0.05 and 0.3 lower than a second refractive index of the first waveguide portion.

12. The semiconductor structure according to any preceding claim, wherein:
the first direction is substantially perpendicular to the planar surface.

13. The semiconductor structure according to any one of claims 1 to 11, wherein:
the first direction is substantially parallel to the planar surface.

14. A photonic integrated circuit comprising a semiconductor structure in accordance with any preceding claim.

15. The photonic integrated circuit according to claim 14, wherein an end of the first waveguide portion is configured for connection with a waveguide external to the photonic integrated circuit, for coupling light into and/or out of the photonic integrated circuit.

16. A method of manufacturing a semiconductor structure according to any of claims 1 to 13, for a photonic integrated circuit, the method comprising:
at least partly forming a substrate comprising a planar surface; and
at least partly forming a waveguide comprising:
a first waveguide portion tapered for a first spot size conversion of light and in contact with a first portion of the planar surface; and
a second waveguide portion in contact with a second portion of the planar surface next to the first portion of the planar surface, wherein a size of the first waveguide portion in a first direction perpendicular to a light propagation direction is less than a size of the second waveguide portion in the first direction for a second spot size conversion of the light.

17. The method according to claim 16, wherein at least partly forming the waveguide comprises:
depositing a first waveguide material of a first thickness on the planar surface;
removing the first waveguide material of the first thickness to provide an exposed portion of the planar surface; and
depositing a second waveguide material of a second thickness on the exposed portion of the planar surface.

18. The method according to claim 17, wherein:
removing the first waveguide material of the first thickness to expose the second portion provides the first waveguide portion of the first waveguide material; and
the method comprises depositing a cladding material on the first waveguide material before removing the first waveguide material of the first thickness to expose the second portion of the planar surface.

19. The method according to claim 17 or claim 18 comprising:
partly removing the second waveguide material of the second thickness to provide the second waveguide portion.

20. The method according to claim 19 comprising:
depositing cladding material to contact the sides of the first waveguide portion which extend away from the planar surface.

21. The method according to claim 17, wherein:
the second waveguide portion comprises the first waveguide material;
the first thickness is greater than the second thickness; and
the method comprises depositing cladding material of a third thickness on second waveguide material, wherein the second thickness and the third thickness together are substantially the same as the first thickness.
